(19) United States
(12) Patent Application Publication
(10) Pub. No.: US 2019/0306094 A1
(43) Pub. Date: Oct. 3, 2019

(54) DYNAMIC COMMUNICATION OF CAPABILITY USING HEADERS

(71) Applicant: Beijing Yi Zhang Yun Feng Technology Co., Ltd., Beijing (CN)

(72) Inventors: Junyan Liu, Beijing (CN); Xiaoyu Ma, Beijing (CN); Liang Zhao, Beijing (CN); Yupeng Liang, Beijing (CN); Qian Huang, Beijing (CN)

(21) Appl. No.: 16/305,415

(22) PCT Filed: Jun. 2, 2016
(86) PCT No.: PCT/CN2016/084467

§ 371 Date: Nov. 29, 2018

(51) Int. Cl. H04L 12/58; H04L 29/06

(52) U.S. Cl. CPC H04L 51/06; H04L 69/22

(57) ABSTRACT

In various example embodiments, a system and method for dynamic communication of capability using headers are presented. A message header that indicates one or more communication protocols is generated. The one or more communication protocols apply to a message being transmitted to a client device. The message header is embedded into a first message, the first message corresponding to the communication protocols indicated in the message header. The first message is transmitted to the client device.

### TECHNICAL FIELD

Embodiments of the present disclosure generally relates to the technical field of special-purpose machines that facilitate interaction with communication systems including computerized variants of such special-purpose machines and improvements to such variants, and to the technologies by which such special-purpose machines become improved compared to other special-purpose machines that facilitate interactions with the communication systems. Specifically, the present disclosure addresses systems and methods to manage communications and more particularly, but not by way of limitation, to manage dynamic communication of capability using headers.

### BACKGROUND

Conventionally, messages are exchanged between a client device and a server. Usually, before messages are transmitted between the client device and the server, a dedicated negotiation process usually takes place to make sure that the client device and the server are capable of communicating with one another. The dedicated negotiation process may also involve the authentication of one or more devices.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating components of a capability negotiation system, according to some example embodiments.

FIG. 3-5 are flowcharts illustrating operations of the capability negotiation system in performing a method of dynamically communicating capability using headers, according to some example embodiments.

FIG. 6 is a block diagram illustrating one or more components of an example message, according to some example embodiments.

FIG. 7 is a flowchart illustrating an example flow of data between a client device and a server, according to some example embodiments.

FIG. 8 is an example user interface that depicts a plurality of messages, according to some example embodiments.

FIG. 9 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various example embodiments of the subject matter discussed herein. It will be evident, however, to those skilled in the art, that embodiments of the subject matter may be practiced without these specific details.

Example methods (e.g., algorithms) facilitate dynamically communicating capability using headers, and example systems (e.g., special-purpose machines) are configured to facilitate dynamically communicating capability using headers. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

In various example embodiments, an example system generates message headers that indicate one or more communication protocols. The communication protocols apply to certain messages being transmitted by the system. For instance, the communication protocols indicate various techniques or algorithms used to assemble or package a message. The communication protocols further indicate software that can be used to view the message on a client device.

Once the message headers are generated by the example system, the example system embeds the message headers into messages that correspond to the one or more communication protocols. In other words, each message has a message header that is embedded into the message. Once embedded, the example system transmits the messages to a client device. Since the message headers indicate the communication protocols used to assemble the message, the client device is able to unpack or view the message using the same communication protocols and without having to go through a separate negotiation or notification process. In example embodiments, the client device has libraries that include files which support and correspond to the communication protocols. In other words, the files are used by the client device to unpack or view the message. As further discussed below, the libraries are generated by the example system and transmitted from the example system to the client device.

In various example embodiments, since each message is embedded with a message header, the communication protocols can vary for each message. For example a first message header for a first message may indicate a first set of communication protocols. Similarly, a second message header for a second message may indicate a second set of communication protocols. By using message headers, this eliminates a need for the example system to transmit a separate notification to the client device to indicate changes in communication protocols.

Accordingly, one or more of the methodologies discussed herein may obviate a need for example systems to transmit a separate notification to the client device to indicate changes in communication protocols, which may have the technical effect of reducing computing resources used by one or more devices within the system. Examples of such computing resources include, without limitation, processor cycles, network traffic, memory usage, storage space, and power consumption.

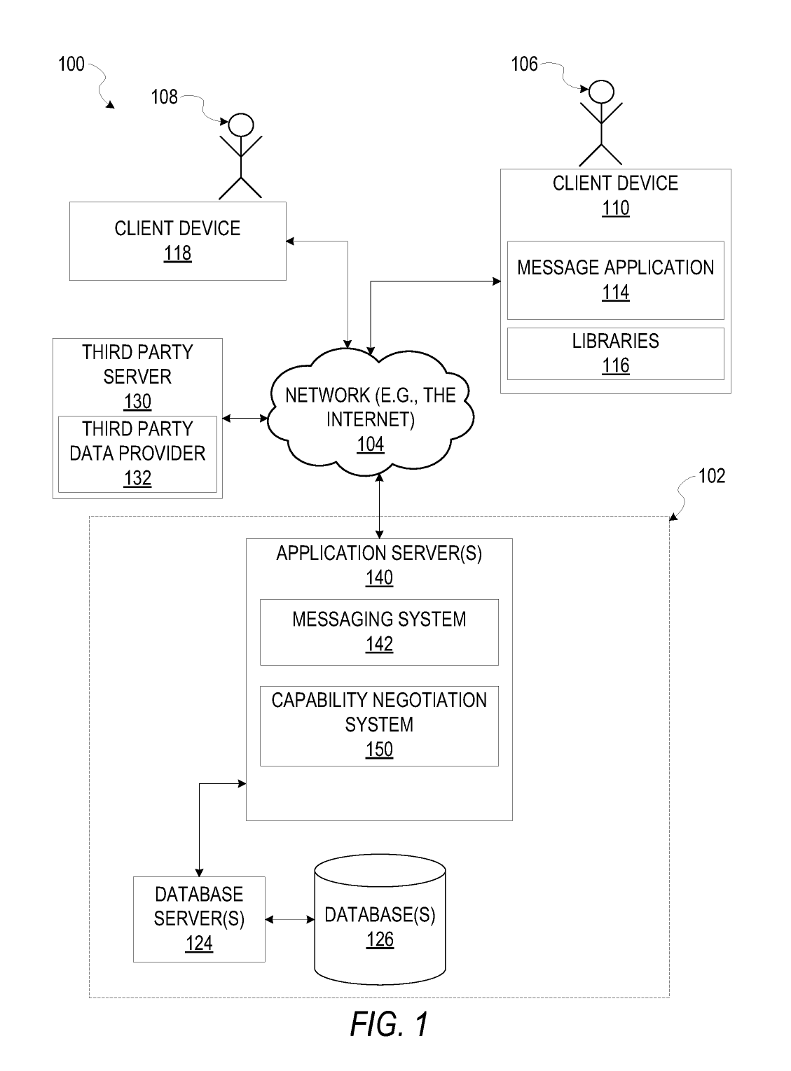

With reference to FIG. 1, an example embodiment of a high-level client-server-based network architecture 100 is shown. A networked system 102, in the example form of a network-based capability negotiation system, provides server-side functionality via a network 104 (e.g., the Internet, local area network (LAN), or wide area network (WAN)) to one or more client devices (e.g. client device 110 and client device 118) that have access to the network 104. Moreover, FIG. 1 illustrates, for example, a message application 114 executing on client device 110. The client device 110 also includes one or more libraries 116 that support the functions of the message application 114. The one or more libraries 116, in some instances, are downloaded onto the client device 110 as part of the message application 114.

A user 106 may be a person, a machine, or other means of interacting with the client devices 110. In example embodiments, the user 106 is not part of the network architecture 100, but interacts with the network architecture 100 via the client device 110 or other means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 for presentation to the user 106. In this way, the user 106 can interact with the networked system 102 using the client device 110. Further, the user 106 may own or operate more than one client device (e.g., client device 110). Likewise, a user 108 may be a person, a machine, or other means of interacting with the client device 118.

The client device 110 comprises, but is not limited to, a mobile phone, desktop computer, laptop, smart phones, tablets, multi-processor systems, microprocessor-based or programmable consumer electronics or any other communication device that a user may utilize to access the networked system 102. In some embodiments, the client device 110 includes components that are used to display information (e.g., in the form of user interfaces). In further embodiments, the client device 110 may comprise one or more of touch screens, accelerometers, gyroscopes, cameras, microphones, global positioning system (GPS) devices, and so forth. Moreover, although FIG. 1 only shows the client device 110, there may be multiple client devices included in the network architecture 100.

In one embodiment, the networked system 102 is a network-based capability negotiation system that receives data over the network 104, assembles the received data into messages, generates message headers for the messages, and transmits the messages with the generated message headers. In example embodiments, one or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks. Any one or more portions of the network 104 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

The client device 110 comprises one or more applications that allow the client device 110 to communicate with the network-based capability negotiation system including, but not limited to, a message application 114. The message application 114 provides functionality that enables the client device 110 to communicate with an application server (e.g., a messaging system 142 or a capability negotiation system 150). In some embodiments, the client device 110 also communicates with other client devices (e.g., client device 118) through the messaging system 142. For example, the messaging system 142 receives data from the client device 118 and subsequently communicates the data (e.g., a message) to the client device 110. In some embodiments, the message application 114 is also configured to perform operations locally on the client device 110. For instance, the message application 114 is configured to display a user interface. Moreover, the user interface, in some instances, is displayed with data received from the server (e.g., the messaging system 142 or the capability negotiation system 150). The client device 110 also includes one or more libraries 116 that support the functions of the message application 114. For instance, the one or more libraries 116 includes files that enable the message application 114 to display messages on the client device 110.

Application servers 140 host the messaging system 142 and the capability negotiation system 150, each of which may comprise one or more modules, engines, or applications and each of which may be embodied as hardware, software, firmware, circuitry, or any combination thereof. The application servers 140 are, in turn, shown to be coupled to one or more database servers 124 that facilitate access to one or more information storage repositories or database(s) 126. In an example embodiment, the databases 126 are storage devices that store information to be communicated to the messaging system 142. In various example embodiments, the messaging system 142 provides data to the capability negotiation system 150. The data includes, for example, text, audio, images, or video.

Also shown in FIG. 1 is a third party server 130 that hosts a third party data provider 132. In some example embodiments, the third party data provider 132 provides data that is sent over the network 104 to the capability negotiation system 150.

The capability negotiation system 150 generates one or more message headers that indicate communication protocols for sending and receiving messages. The communication protocols may include encryption algorithms, compression algorithms, authentication protocols, software versions, transportation protocols, and the like. In particular, the capability negotiation system 150 adds a generated message header to a message received from a device of a first user (e.g., client device 118) prior to transmission of that message to a device of a second user (e.g., client device 110). As a result, the device of the second user receives the message header and the message in a single transmission. Since the message header indicates the communication protocols and the message header is sent with the message itself, the device of the second user receives the message contents and information on how to unpack the message (e.g., the communication protocols indicated in the message header).

In some example embodiments, the capability negotiation system 150 communicates with the messaging system 142 (e.g., receiving data that is stored in the database 126). In an alternative embodiment, the capability negotiation system 150 is included as part of the messaging system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example.

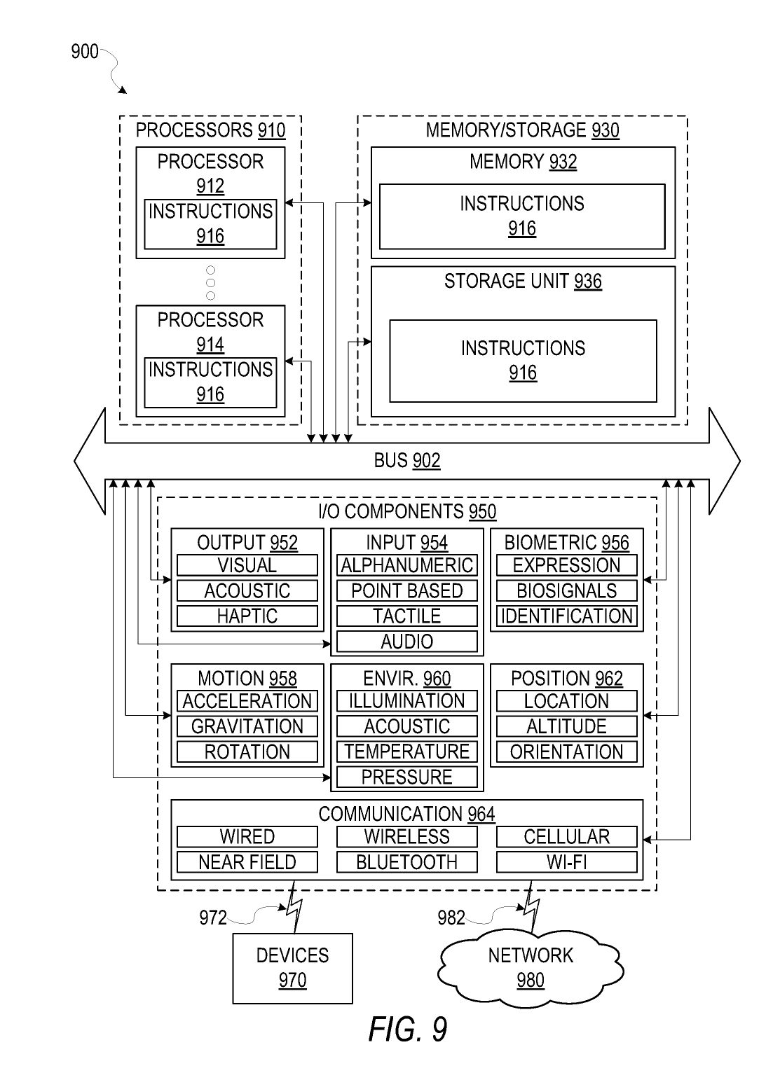

Any of the systems or machines (e.g., databases, devices, servers) shown in FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 9, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the systems or machines illustrated in FIG. 1 may be combined into a single system or machine, and the functions described herein for any single system or machine may be subdivided among multiple systems or machines.

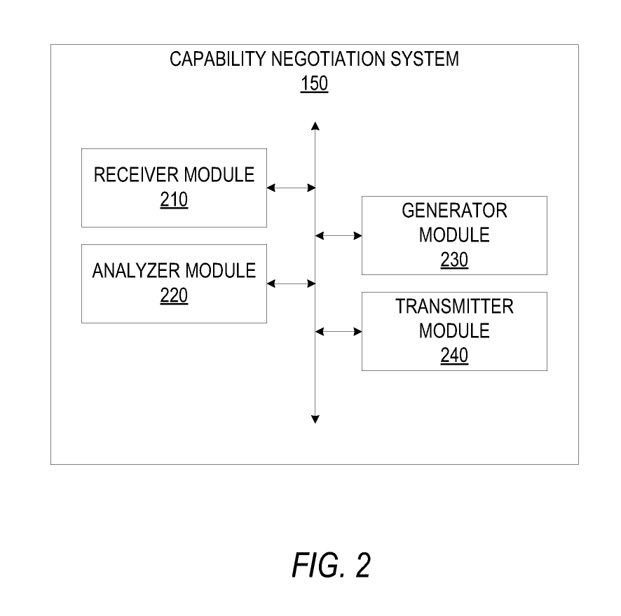

FIG. 2 is a block diagram illustrating components of the capability negotiation system 150, according to some example embodiments. The capability negotiation system 150 is shown as including a receiver module 210, an analyzer module 220, a generator module 230, and a transmitter module 240, all configured to communicate with each other (e.g., via a bus, shared memory, or a switch). Any one or more of the components (e.g., modules) described herein may be implemented using hardware alone (e.g., one or more processors of a machine) or a combination of hardware and software. For example, any component described herein may physically include an arrangement of one or more of the processors or configure a processor (e.g., among one or more processors of a machine) to perform the operations described herein for that module. Accordingly, different components described herein may include and configure different arrangements of the processors at different points in time or a single arrangement of the processors at different points in time. Each component (e.g., module) described herein is an example of a means for performing the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices.

In various example embodiments, the receiver module 210 is configured to receive data from a data provider (e.g., another user or third party data provider that is sending a message). The data provider provides content that is generated into a message by the generator module 230. For example, the data is generated into a payload portion of the message that is displayed to a recipient of the message. As stated earlier, the data may include text, video, audio, images, or any suitable combination thereof. The data provider, in some instances, provides a stream of data to the receiver module 210. In further example embodiments, the receiver module 210 is configured to receive a response from the client device after the message is transmitted to the client device. The response may include an acknowledgement indicating that the message is successfully received by the client device. In some embodiments, the receiver module 210 is located within the messaging system 142.

In various example embodiments, the analyzer module 220 is configured to analyze data that is received from the data provider (e.g., another user or third party data provider). Example data includes text, video, audio, or images. The analyzer module 220, in some instances, identifies one or more types of content received from the data provider. As such, the analyzer module 220 determines that the data includes text, video, audio, images, or any suitable combination thereof. The analyzer module 220, in further instances, determines a size of the data received from the data provider. Depending on the size of the data received from the data provider, the analyzer module 220, is configured to partition the data into one or more sections, as further explained below.

In various example embodiments, the analyzer module 220 determines one or more communication protocols based on the analysis of the data. For example, the one or more communication protocols is determined based on the type of content identified as being received from the data provider. In further instances, the one or more communication protocols are determined based on an amount of data (e.g., text, video, audio, or images) received from the data provider. In some embodiments, the data is only available to certain authorized users. Therefore, in some instances, the communication protocols are determined based on permissions associated with the data.

In example embodiments, the amount of data or the type of data identified as being received from the data provider corresponds to certain algorithms or techniques (e.g., encryption, decryption, or compression) that are analyzed as being most efficient methods of assembling the data into a message. Moreover, the analyzed algorithms or techniques correspond to specific versions of software. For example, a compression algorithm that is optimal for the identified data type may correspond to a specific version of a client-side operating system (e.g., a mobile operating system). Accordingly, in example embodiments, the client device is known to the capability negotiation system 150 or the messaging system 142.

In some example embodiments, the analysis module 220 analyzes the stream of data received by the receiver module 210. The analysis module 220 partitions the stream of data into one or more sections of data. Further, in some instances, each of the partitioned sections of data is assembled into one or more messages by the generator module 230, as further discussed below.

In some instances, the analyzer module 220 determines a set of communication protocols for each of the partitioned sections of data. As an example, the analyzer module 220 determines a first set of communication protocols and a second set of communication protocols. The first set of communication protocols apply to a first partition or section of the analyzed data. The second set of communication protocols apply to a second partition or section of the analyzed data. In further instances, the first set of communication protocols apply to a first type of content and the second set of communication protocols apply to a second type of content.

In various example embodiments, the generator module 230 is configured to generate a message header that indicates one or more communication protocols (e.g., communication standards). In some embodiments, the one or more communication protocols relate to a message being sent over the network because they indicate at least how the message is assembled (e.g., generated) or delivered. As a result, a message that is assembled using the communication protocols will correspond to the communication protocols indicated in the message header (e.g., complies with the communication protocols indicated in the message header). Moreover, since the communication protocols indicate methods of assembling and delivering the message, the communication protocols for each message may depend on the data in the message. In other words, in some instances, the communication protocols of each message will vary based on the data assembled into the message, as further explained below. Accordingly, the message headers for each message will also vary, and the generator module 230 is further configured to generate a message header for each of the messages.

Example communication protocols may include a compression algorithm, a compression rate, a software version, an encryption algorithm, an authentication protocol, and the like. In various example embodiments, the authentication protocol indicates a set of procedures that is used to authenticate a device (e.g., client device). Example authentication protocols may include requiring a password or other forms of identification from a user of the client device before the message is displayed on the client device.

In various example embodiments, the generator module 230 is configured to embed the generated message header into a message. Once the message header is embedded into the message, the message header becomes a part of the message. Subsequently, the transmitter module 240 is configured to send the message containing the message header in a single transmission. For multiple messages, the generator module 230 is configured to embed respective generated message headers into each of the messages. Since the headers of each message indicate communication protocols that apply to that respective message, the transmitter module 240 sends each of the messages in succession without providing a separate message indicating any changes in the communication protocols even if the communication protocols vary for each of the messages. Effectively, the messages are communicated to a client device without any interruptions to renegotiate capability.

In various example embodiments, the generator module 230 is configured to generate a library that enables a client device receiving messages to display the messages that are transmitted to the client device. The library includes information that is used to support the display of messages in a user interface of the client device. In some instances, the library has a file for each of the communication protocols indicated in the message header. The library may be generated and provided to the client device at any time and can be periodically updated as communication protocols change. Accordingly, the capability negotiation system 150 or the messaging system 142 may maintain a record (e.g., profile) for each user or client device that includes an indication of the content of their respective libraries and device capabilities (e.g., device operating system).

In various example embodiments, the generator module 230 is configured to assemble or generate a message based on the one or more communication protocols. In other words, the message is assembled using the one or more communication protocols that are indicated in the corresponding message header. In further embodiments, the same communication protocols used to assemble or generate the message are also usable on the client side to unpack the message (e.g., cause display of the message on a client device).

In various example embodiments, the transmitter module 240 is configured to transmit messages with the message header to a client device (e.g., client device 110). Accordingly, the messages are sent by the transmitter module 240 across the network 104 to the client device 110.

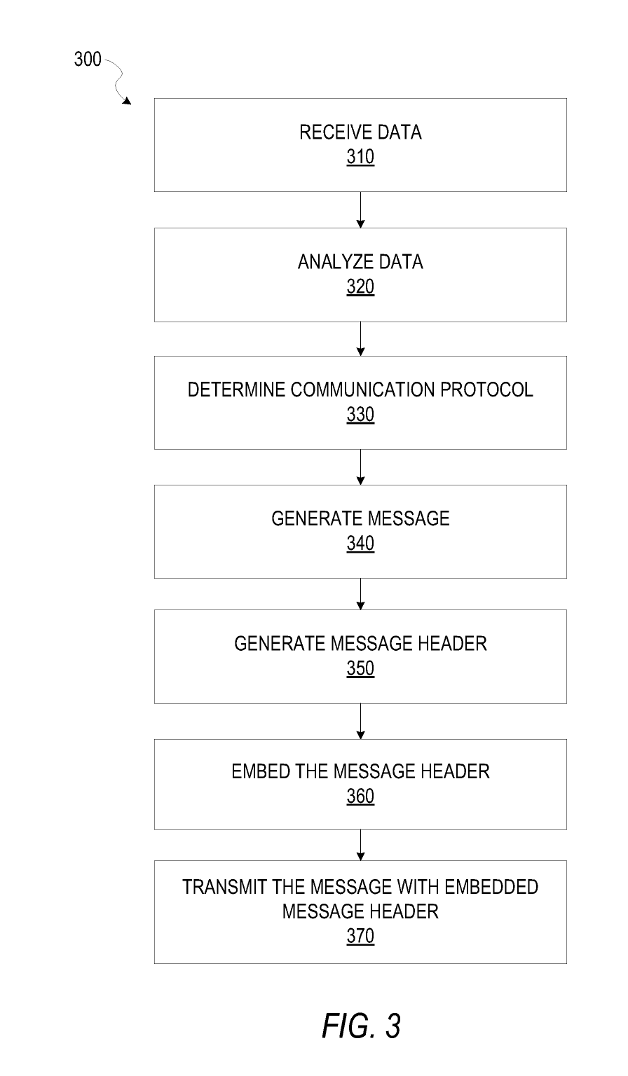

FIG. 3-5 are flowcharts illustrating operations of the capability negotiation system 150 in performing a method 300 of dynamically communicating capability using headers in a message, according to some example embodiments. Operations in the method 300 may be performed in part or in whole by components of the capability negotiation system 150, which can be embodied either in whole or in part in one or more application servers 140 of a networked system 102, using components described above with respect to FIG. 2. Accordingly, the method 300 is described by way of example with reference to the capability negotiation system 150. However, it shall be appreciated that at least some of the operations of the method 300 may be deployed on various other hardware configurations or be performed by similar components residing elsewhere in the network architecture 100. Therefore, the method 300 is not intended to be limited to the capability negotiation system 150. As shown in FIG. 3, the method 300 includes operations 310, 320, 330, 340, 350, 360, and 370.

At operation 310, the receiver module 210 receives data from a data provider. For example, a first user sends data as part of a message to a second user (e.g., texting or SMS). As discussed above, the data may include text, video, images, or any suitable combination thereof. In example embodiments, the data provider, in some instances, corresponds to the first user of the networked system 102. In other words, the first user of the networked system 102 provides the data to the receiver module 210 through a client device of the first user. In some instances, the data provider is a third party server that publishes information and transmits the published information to the receiver module 210. In some embodiments, the messaging system 142 receives the data from the first user of the networked system 102 (e.g., client device 118). Moreover, once the data is received, the messaging system 142 temporarily stores the data and then provides the data to the receiver module 210 for processing by the capability negotiation system 150.

At operation 320, the analyzer module 220 analyzes the data received from the data provider. In some instances, the analyzer module 220 identifies one or more types of content in the data received from the data provider. Since the data may include text, video, or images, the data can be identified by the analyzer module 220 as being textual data, video data, or image data. If the data includes a combination of text, video, or image, the analyzer module 220, in some instances, separates the data according to content type.

In some embodiments, the analyzer module 220, is configured to determine a size of the data received from the data provider and classify the data based on its size. In this regard, for example, the analyzer module 220 may determine that a large amount of data is being received from the data provider. A large amount of data, in some instances, may be classified by the analyzer module 220 as data that exceeds a threshold amount of data (e.g., a threshold amount of memory). By contrast, the analyzer module 220 may determine that the amount of data received from the data provider is below the threshold amount. Depending on the size of the data, the analyzer module 220 may partition the data into smaller sections, as further explained below.

At operation 330, the analyzer module 220 determines one or more communication protocols based on the analysis of the data. In some embodiments, the one or more communication protocols are determined based on the type of content identified as being received from the data provider. For example, if the type of content is video data, then the analyzer module 220 selects a data compression algorithm that is applicable for the video (e.g., optimized for video). In some example embodiments, the analyzer module 220 selects an encryption algorithm that matches the type of content received from the data provider. In some instances, the data is available only to certain authorized users. In this case, the analyzer module 220 selects an authentication protocol to protect the data from unauthorized users.

In various example embodiments, the analyzer module 220 determines that a recipient client device configured to receive messages from the capability negotiation system 150 includes a client component library that enables the recipient client device to display the messages that are transmitted to the client device. In some embodiments, the analyzer module 220 determines that the recipient client device has an outdated version of the client component library, and the analyzer module 220 determines that the recipient client device needs to be updated with a current client component library.

Moreover, the analyzer module 220, in some instances, identifies a software version that can be used to unpack a message that was assembled using the determined communication protocols. As an example, the identified software version is a mobile operating system that executes on the client device. Further, a specific version of the mobile operating system includes the libraries that support the algorithms identified by the analyzer module 220. In other words, the identified software version is compatible with the determined communication protocols. In this regard, the analyzer module 220 in some instances, determines that a recipient client device includes the identified software version.

At operation 340, the generator module 230 assembles the data into a message based on the one or more communication protocols. In other words, the generator module 230 uses the one or more communication protocols to generate the message. As further explained below, the generator module 230 implements the compression algorithm that was determined by the analyzer module 220 to be the most compatible with the received data. As also further explained below, the generator module 230 may also implement the encryption algorithm that was determined by the analyzer module 220 to be most compatible with the received data. As such, the generator module 230 protects the data in the message using the authentication protocol selected by the analyzer module 220.

At operation 350, the generator module 230 generates a message header that indicates the one or more communication protocols used to generate the message. As discussed above, the one or more communication protocols are determined by the analyzer module 220 at operation 330. Also, the message is assembled using the determined one or more communication protocols.

The generated message header includes fields that indicate the one or more communication protocols used to generate the message. In other words, the generated message header may include a field that is used to indicate a specific compression algorithm, a field that is used to indicate a specific encryption algorithm, and the like. Accordingly, the fields in the message header are filled in with the one or more communication protocols as determined by the analyzer module 220.

At operation 360, the generator module 230 embeds the generated message header into the generated message. Accordingly, the generator module 230 adds the generated message header to the generated message. In one embodiment, the generator module 230 adds the message header to a header portion of the message that precedes a payload portion of the message. The payload portion of the message includes the content that is to be displayed to the recipient of the message at the client device of the recipient.

At operation 370, the transmitter module 240 transmits the message with the embedded message header. The transmitter module 240 transmits the message to one or more client devices for which the message was intended to be sent to by a sender of the message. In example embodiments, each of the one or more client devices execute a message application (e.g., message application 114) provided by the messaging system 142 in order to send and receive messages in accordance with example embodiments discussed herein.

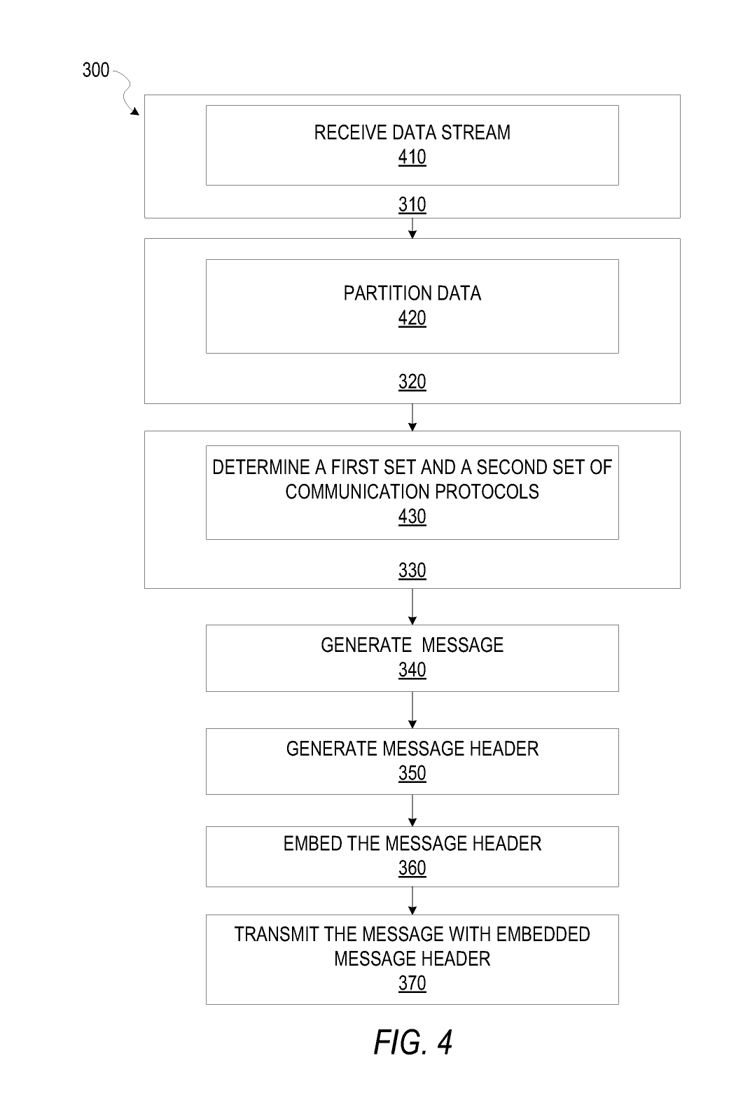

As shown in FIG. 4, the method 300 may include one or more of operations 410, 420, and 430. The operation 410 may be performed as part of the operation 310. The operation 420 may be performed as part of the operation 320. The operation 430 may be performed as part of the operation 330.

At operation 410, the receiver module 210 receives a stream (e.g., sequence) of data from a data provider. The stream of data may be sent from the data provider over the network 104 that is in communication with the receiver module 210. In further embodiments, the stream of data comprises a series of packets being transmitted by the data provider to the receiver module 210. Moreover, each of the packets contains data from the data provider.

At operation 420, the analyzer module 220 partitions the data into one or more sections (e.g., a first section and a second section). As previously discussed, the analyzer module 220 determines a size of the data being received from the data provider. The analyzer module 220, in some instances, partitions the data into the one or more sections based on the determined size of the data. For example if the size of the data being received exceeds a threshold size, the analyzer module 220 partitions the data into one or more smaller sections. The analyzer module 220, in other instances, partitions the data into one or more sections based on the identified types of content. For example, the analyzer module 220 partitions the data into a section that includes video content and a section that includes image content.

At operation 430, the analyzer module 220 determines a first set and a second set of communication protocols. The first set of communication protocols, in some instances, is different from the second set of communication protocols. For instance, the first set of communication protocols may include one or more of, for example, a first compression algorithm, a first encryption algorithm, a first identified version of software, and the like. In further instances, there may exist some communication protocols that appear in both the first and second sets. For example, the second set of communication protocols may be a variant of the first set of communication protocols.

The first set and the second set of communication protocols are determined based on the partitioned data. In some instances, a first set of communication protocols is determined based on the first section of data, while a second set of communication protocols is determined based on the second section of data. In example embodiments, each section of data is assembled into a respective message by the generator module 230. For example, the generator module 230 assembles the first section of data into a first message based on the first set of communication protocols. As another example, the generator module 230 assembles the second section of data into a second message based on the second set of communication protocols.

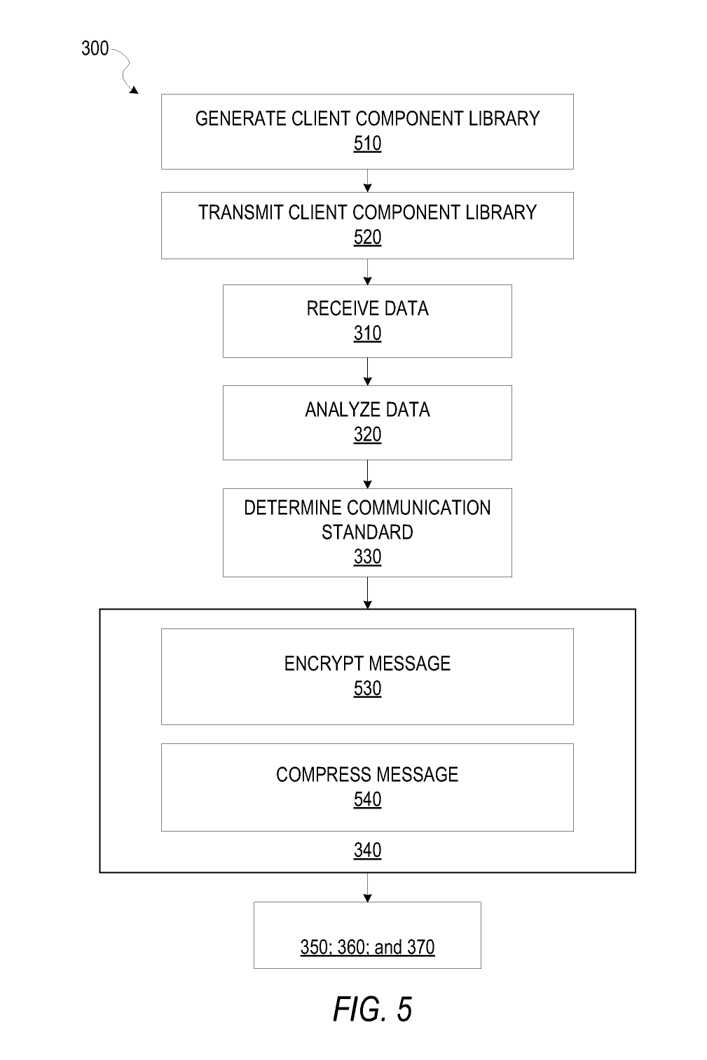

As shown in FIG. 5, the method 300 may include one or more of operations 510, 520, 530, and 540. The operations 510 and 520 may be performed prior to the operation 310 in accordance with some embodiments. The operations 530 and 540 may be performed as part of the operation 340 (e.g., a subroutine).

At operation 510, the generator module 230 generates a client component library (e.g., client-side library) that enables the client device to display the transmitted message in a user interface. As stated above, the client component library enables a client device to manage and display messages that are transmitted to the client device (e.g., unpack the message). The client component library includes files that support the one or more communication protocols determined by the analyzer module 220. For example, the client component library may contain files that are necessary in order to perform a client-side authorization of the client device according to the authentication protocols. Likewise, the files contained in the client component library may be necessary in order to decrypt or decompress the data included in the message. In some instances, the client component library also includes one or more versions of software that can be used to unpack the message. A message header may also indicate a proper version of the software from the client component library to be used to display the message.

At operation 520, the transmitter module 240 transmits the client component library to the client device. In other words, the transmitter module 240 causes the client component library (e.g., libraries 116) to be downloaded onto the client device. Once the client component library is downloaded onto the client device, the client device is compatible with one or more communication protocols determined by the analyzer module 220 because the library includes files that support the one or more communication protocols. In some instances, the client component library is transmitted to any client device that communicates with the capability negotiation system 150. As a result of the operation 520, the capability negotiation system 150 is guaranteed to be compatible with any client device that communicates with the capability negotiation system 150.

In various example embodiments, the client component library is an updated or current version that is compatible with the one or more communication protocols. Moreover, the transmitter module 240 transmits the updated client component library to the client device based on a determination that the client device needs to be updated with the current version of the client component library.

At operation 530, the generator module 230 encrypts a payload (also referred to as a “payload portion”) of the message using an encryption algorithm determined by the analyzer module 220 as part of the communication protocol. The encryption algorithm, in some instances, encrypts information included in the payload of the message such that the information included in the payload of the message is only available to an authorized user.

At operation 540, the generator module 230 compresses the payload of the message using a compression algorithm determined by the analyzer module 220. The compression algorithm is used to compress the information included in the payload of the message. For example, the compression algorithm compresses the information included in the payload of the message which results in the information being expressed in a more compact form. Moreover, a size of the message decreases as a result of the compression process.

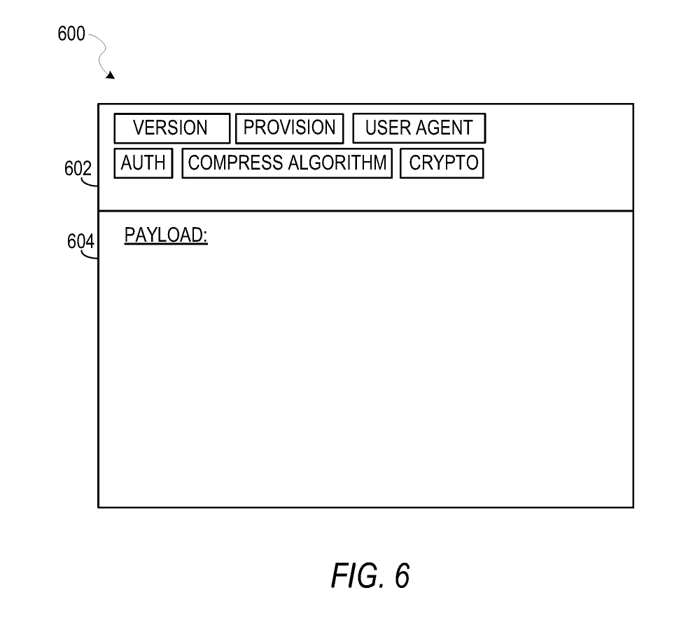

FIG. 6 is a block diagram 600 illustrating one or more components of an example message, according to some example embodiments. As shown in FIG. 6, the message includes a message header 602 and a message payload 604. The message header 602 includes one or more fields that each correspond to a communication protocol. In other words, each of the fields in the message header 602 is used to indicate a communication protocol. The message payload 604, in some instances, includes the contents of the message that is actually displayed to a recipient of the message.

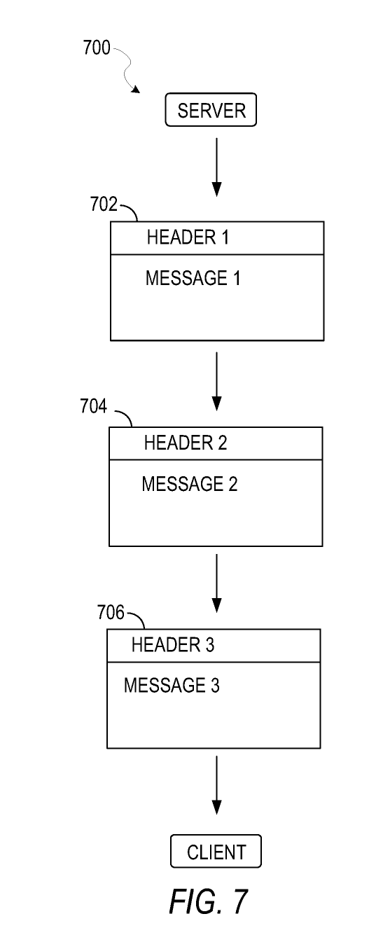

FIG. 7 is a flowchart 700 illustrating an example flow of data between a client device and an application server hosting the capability negotiation system 150, according to some example embodiments. As shown in FIG. 7, there are three example messages as part of a series of messages. The series of messages includes a first message 702, a second message 704, and a third message 706 shown as being transmitted from the application server to the client device. Each of the messages includes a header that indicates communication protocols for each respective message. In some instances, the communication protocols for each of the messages 702, 704, and 706 are different from one another. Moreover, since the message headers indicate the communication protocols for each respective message, there is no need for the application server to send a separate message to indicate a change in the communication protocols.

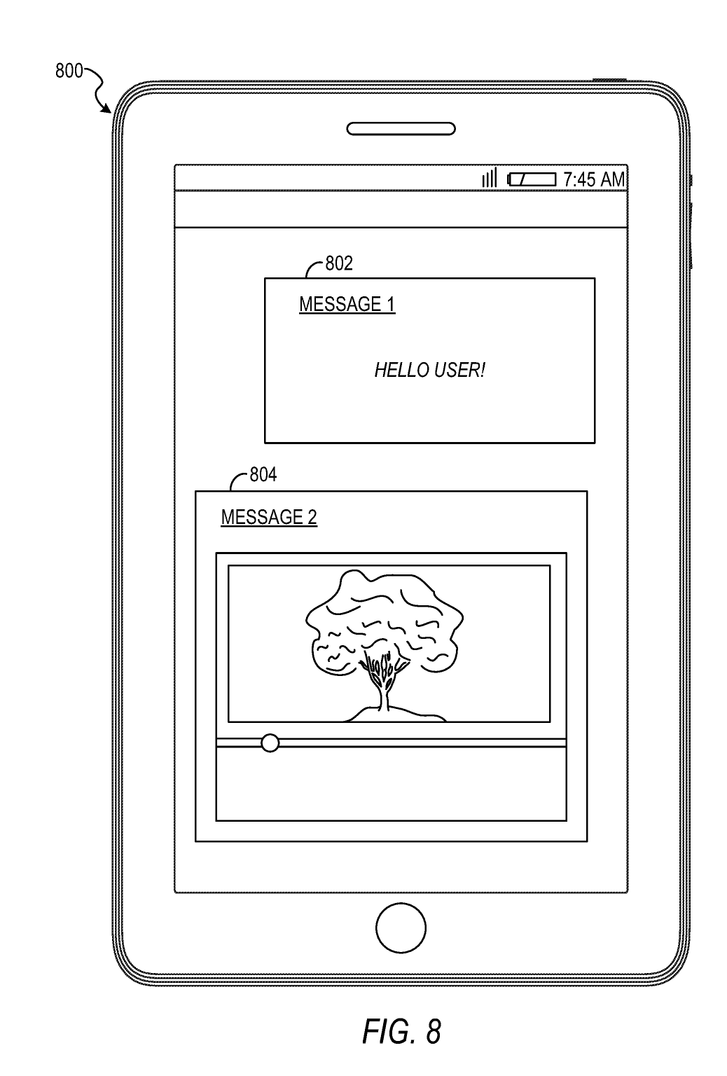

FIG. 8 is an example user interface 800 that depicts a plurality of messages, according to some example embodiments. As shown in FIG. 8, there is a first message 802 and a second message 804. The example user interface 800 is displayed in a client device operated by a user. Moreover, the first message 802 includes text data that is displayed in the user interface 800. The second message 804 includes a video that is displayed in the user interface 800.

In example embodiments, the first message corresponds to a first set of communication protocols whereas the second message corresponds to a second set of communication protocols. As an example, the first message may be compressed using a first compression algorithm that is different from a compression algorithm used to compress the second message. As another example, the first message may be encrypted using a first encryption algorithm that is different from an encryption algorithm used to encrypt the second message. Using information indicated in message headers for each of the messages (e.g., the first message and the second message), the client device is able to unpack each message and display them in the user interface 800 without the need for a separate message indicating a change in communication protocols applied to the first message and the second message. In further instances, the client device also downloads a client component library from the capability negotiation system 150. In some instances, the client component library is downloaded to the client device prior to receipt of any messages. As previously discussed, the client component library includes files that support the one or more communication protocols indicated in the message headers.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. The instructions transform the general, non-programmed machine into a particular machine specially configured to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 912 and processor 914 that may execute instructions 916. The term “processor” is intended to include multi-core processor that may comprise two or more independent processors (sometimes referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972 respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A method comprising:
generating a message header that indicates a set of one or more communication protocols used to generate a message being transmitted to a client device;
embedding, using one or more processors, the message header into the message; and
transmitting the message with the embedded message header to the client device.

2. The method of claim 1, further comprising:
receiving data from a data provider, the data used to generate a payload portion of the message;
analyzing the data received from the data provider;
determining the set of one or more communication protocols based on the analyzing of the data; and
generating the message using the one or more communication protocols.

3. The method of claim 1, further comprising:
receiving a stream of data from the data provider, the stream of data used to generate a payload portion of the message;
partitioning the data into at least a first section and a second section;
determining a set of communication protocols for each of the sections; and
generating a plurality of messages, wherein a first message of the plurality of messages is based on a first set of communication protocols applied to the first section and a second message is based on a second set of communication protocols applied to the second section, the first set of communication protocols and the second set of communication protocols being different.

4. The method of claim 2, wherein:
the analyzing includes identifying a type of content in the data; and
the determining the one or more communication protocols is based on the identified type of content.

5. The method of claim 1, wherein the communication protocols include at least one of:
a software version;
an encryption algorithm;
an authentication protocol; or
a compression algorithm.

6. The method of claim 1, further comprising:
generating a client component library that enables the client device to manage and display the transmitted message in a user interface, the library including files that correspond to the set of the one or more communication protocols; and
transmitting the client component library to the client device.

7. The method of claim 6, further comprising:
determining that the client device includes an outdated version of the client component library; and
wherein the transmitting the client component library comprises transmitting an updated version of the client component library.

8. The method of claim 1, further comprising:
generating a second message header that indicates a second set of one or more communication protocols, the second set of one or more communication protocols being different from the set of one or more communications protocols;
embedding the second message header into a second message; and
transmitting the second message to the client device, the transmitting being performed without providing a separate notification indicating a transition from the set of one or more communication protocols to the second set of one or more communication protocols.

9. The method of claim 2, wherein the generating the message includes encrypting the payload portion of the message based on an encryption algorithm indicated in the message header.

10. The method of claim 2, wherein the generating the message includes compressing the payload portion of the message based on a compression algorithm indicated in the message header.

11. A system comprising:
one or more processors and executable instructions accessible on computer-readable medium that, when executed, configure the one or more processors to at least:
generate a message header that indicates a set of one or more communication protocols used to generate a message being transmitted to a client device;
embed, using one or more processors, the message header into the message; and
transmit the message with the embedded message header to the client device.

12. The system of claim 11, wherein the one or more processors are further configured to:
receive data from a data provider, the data used to generate a payload portion of the message;
analyze the data received from the data provider;
determine the set of one or more communication protocols based on the analyzing of the data; and
generate the message using the one or more communication protocols.

13. The system of claim 11, wherein the one or more processors are further configured to:
receive a stream of data from the data provider, the stream of data used to generate a payload portion of the message;
partition the data into at least a first section and a second section;
determine a set of communication protocols for each of the sections;
generate a plurality of messages, wherein a first message of the plurality of messages is based on a first set of communication protocols applied to the first section and a second message is based on a second set of communication protocols applied to the second section, the first set of communication protocols and the second set of communication protocols being different.

14. The system of claim 11, wherein the communication protocols include at least one of:
a software version;
an encryption algorithm;
an authentication protocol; or
a compression algorithm.

15. The system of claim 11, wherein the one or more processors are further configured to:
generate a client component library that enables the client device to manage and display the transmitted message in a user interface, the library including files that correspond to the set of the one or more communication protocols; and
transmit the client component library to the client device.

16. The system of claim 15, wherein the one or more processors are further configured to:
determine that the client device includes an outdated version of the client component library; and
transmit an updated version of the client component library.

17. The system of claim 11, wherein the one or more processors are further configured to:
generate a second message header that indicates a second set of one or more communication protocols, the second set of one or more communication protocols being different from the set of one or more communication protocols;
embed the second message header into a second message; and
transmit the second message to the client device, the transmitting being performed without providing a separate notification indicating a transition from the set of one or more communication protocols to the second set of one or more communication protocols.

18. The system of claim 12, wherein the one or more processors are further configured to:
encrypt the payload portion of the message based on an encryption algorithm indicated in the message header.

19. The system of claim 12, wherein the one or more processors are further configured to:
compress the payload portion of the message based on a compression algorithm indicated in the message header.

20. A machine-readable storage device storing instructions that, when executed by one or more processors of a machine, cause the machine to perform operations comprising:
generating a message header that indicates a set of one or more communication protocols used to generate a message being transmitted to a client device;
embedding the message header into the message; and
transmitting the message with the embedded message header to the client device.
